(19) United States
(12) Patent Application Publication
(10) Pub. No.: US 2012/0294420 A1
(43) Pub. Date: Nov. 22, 2012

(54) ANALYZING METHOD OF PHASE INFORMATION, ANALYZING PROGRAM OF THE PHASE INFORMATION, STORAGE MEDIUM, AND X-RAY IMAGING APPARATUS

(75) Inventor: Kentaro Nagai, Yokohama-shi (JP)

(73) Assignee: CANON KABUSHIKI KAISHA, Tokyo (JP)

(21) Appl. No.: 13/521,264

(22) PCT Filed: Jan. 21, 2011
(86) PCT No.: PCT/JP2011/051683

§ 371 Date: Jul. 10, 2012

(30) Foreign Application Priority Data
Feb. 10, 2010 (JP) 2010-027214

(51) Int. Cl. G01N 23/04; G06F 17/14

(52) U.S. Cl. 378/62; 708/403

(57) ABSTRACT

An analyzing method for deriving phase information by analyzing a periodic pattern of moiré comprises steps of: subjecting at least a part of the periodic pattern of moiré to a windowed Fourier transform by a window function; calculating analytically, based on the moiré subjected to the windowed Fourier transform, information of a first spectrum carrying the phase information, and information of a second spectrum superimposed on the information of the first spectrum; and separating the information of the first spectrum from the information of the second spectrum, to derive the phase information.

### TECHNICAL FIELD

The present invention relates to an analyzing method of phase information, an analyzing program of the phase information, a storage medium, and an X-ray imaging apparatus.

In particular, the present invention relates to a technique for calculating differentiation of a phase wave front of an original incident wave or the phase wave front from a periodic pattern such as a moiré (an interference pattern or an intensity pattern) created by interfering with an incident wave such as light with any phase wave front.

### BACKGROUND ART

There has been known a technique for causing interference using waves with various wavelengths including light and X-rays for use in shape measurement of an object to be detected.

According to the above measurement technique, (coherent) incident light with a constant phase wave front is irradiated on the object and reflected or transmitted.

It has been known that the reflected light or transmitted light changes in wave front depending on the shape or composition of the object.

In light of this, by some method of causing interference, the change is converted to a moiré image (also referred to as an interference pattern, but here moiré is used) and its pattern is analyzed. Accordingly, the phase information (a phase wave front or a differential image of the phase wave front (differential phase image)) changed by this can be calculated.

A typical example of this technique is a wave front measurement technique for measuring the shape of a lens or the like.

Further, in recent years, an X-ray phase imaging technique has been known as a technique using X-rays in medical fields as well.

According to this technique, when an incident X-ray is transmitted through an object, the phase difference caused by a difference in refractive index of the object is derived using a periodic pattern such as moiré.

Each component material in the object has a different refractive index and thus a change in wave front exhibits the corresponding characteristic. In light of this, the phase wave front is detected by interference or the like.

A technique for calculating the change in the original wave front or the phase wave front of incident light from an intensity pattern obtained by the interference is referred to as a phase retrieval method.

There are several kinds of phase retrieval methods and one of them is a windowed Fourier transform method (see “Windowed Fourier transform method for demodulation of carrier fringes,” Opt. Eng. 43(7) 1472-1473 (July 2004), hereinafter referred to as Non Patent Literature 1).

This method allows a phase wave front shape to be calculated by pattern analysis using windowed Fourier transform method of performing a Fourier transform by applying a window function to an intensity pattern.

### CITATION LIST

Non Patent Literature

NPL 1: Windowed Fourier transform method for demodulation of carrier fringes,” Opt. Eng. 43(7) 1472-1473 (July 2004)

NPL 2: A. Momose, et al., Jpn. J. Appl. Phys. 42, L866 (2003)

### SUMMARY OF INVENTION

The above windowed Fourier transform method disclosed in Non Patent Literature 1 has an advantage of improving the resistance of image to noise in comparison with a conventionally used general Fourier transform method, but has the following disadvantage.

The windowed Fourier transform method is basically effective for an object with a relatively smooth change in phase wave front shape, but the derived phase wave front image may be distorted depending on the size of the window function to be used (a full width at half maximum is often used as an indicator thereof).

In particular, when the full width at half maximum of the window function is small, a constant pattern is superimposed on a phase wave front recovery image and thus an accurate phase wave front image may not be derived.

In contrast to this, when the full width at half maximum of the window function is large, the image is difficult to be distorted, but the entire resolution is sacrificed.

For that reason, the windowed Fourier transform method has a problem in that the fine shape of an accurate phase wave front may not be derived depending on the object shape.

These are fundamental problems with the windowed Fourier transform method, and thus even if noise of the original image can be ignored, the noise imposes a limitation on the resolution.

The present invention provides an analyzing method of phase information and the like capable of further improving a resolution thereof in an analysis using a windowed Fourier transform method.

According to an aspect of the present invention, an analyzing method for deriving phase information by analyzing a periodic pattern of moiré comprises steps of: subjecting at least a part of the periodic pattern of moiré to a windowed Fourier transform by a window function; calculating analytically, based on the moiré subjected to the windowed Fourier transform, information of a first spectrum carrying the phase information, and information of a second spectrum superimposed on the information of the first spectrum; and separating the information of the first spectrum from the information of the second spectrum, to derive the phase information.

Further features of the present invention will become apparent from the following description of exemplary embodiments with reference to the attached drawings.

### BRIEF DESCRIPTION OF DRAWINGS

FIG. 1 is a flowchart illustrating a process of calculating a wave front change from moiré describing an embodiment of the present invention.

FIG. 2 is a drawing illustrating a Talbot interferometer for use in describing the embodiment of the present invention.

FIG. 3A is a schematic drawing describing a spectrum of a moiré pattern by a windowed Fourier transform.

FIG. 3B is a schematic drawing describing a spectrum of a moiré pattern by a windowed Fourier transform.

FIG. 4 is a drawing illustrating a structure of an object used in a first embodiment of the present invention.

FIG. 5A is a drawing illustrating a stripe pattern used in the first embodiment.

FIG. 5B is a drawing illustrating a checkerboad pattern used in a second embodiment.

FIG. 6 is a drawing illustrating a moiré used in describing the first embodiment of the present invention.

FIG. 7A is a drawing illustrating a result of wave front recovery in prior art.

FIG. 7B is a drawing illustrating a result of wave front recovery in the first embodiment.

FIG. 8 is a drawing illustrating a moiré used in describing the second embodiment of the present invention.

FIG. 9A is a drawing illustrating a phase wave front differential image along the Y-axis in prior art.

FIG. 9B is a drawing illustrating a phase wave front differential image along the Y-axis in the second embodiment.

FIG. 10A is a drawing illustrating a phase wave front differential image along the X-axis in the second embodiment.

FIG. 10B is a drawing illustrating a phase wave front differential image along the X-axis in prior art.

### DESCRIPTION OF EMBODIMENTS

According to the phase information analyzing method of the present invention, when a periodic pattern of a moiré is analyzed by a windowed Fourier transform method, information about a predetermined spectrum (e.g. 1-th order spectrum carrying phase information is analytically separated from information about another spectrum (e.g. 0-th order spectrum or 2-th or higher order spectrum) superimposed on the information about the predetermined spectrum.

Here, “analytically” refers to a method of calculating spectral data with 0-th order component and 1st and higher order components from two or more data by solving an equation.

That is, the analyzing method of the present invention can predict a spectral shape after Fourier transform because a predetermined window function is used. Therefore, when spectral data with 0-th order component is separated from 1st and higher order components, each spectral data shape can be calculated by solving an equation.

For example, when Gaussian is used as a window function, moiré is formed such that the 0-th order spectrum and the 1st and higher order spectrums are approximated into a Gaussian overlap form by Gaussian transform.

Then, by assuming that each spectrum is Gaussian, the 0-th order spectrum can be analytically separated from the 1st and higher order spectrums.

Then, the wave front shape is calculated from the separated 1st and higher order spectrums. Thus, finer wave front data can be derived than a case in which peak separation is not analytically performed.

Thus, the configuration according to the present embodiment can further improve the resolution. On the contrary, the conventional windowed Fourier transform method may produce a distorted image of the derived phase wave front depending on the size of the used window function. Hereinafter, the detail thereof will be described.

Before that, first, the outline of the windowed Fourier transform method will be described. According to the windowed Fourier transform method, the Fourier transform of a portion extracted by a windowed Fourier transform is divided into a 0-th order spectrum of the background and 1st and higher order spectrums by a moiré pattern.

The phase wave front information in a range extracted by the window function can be derived from the 1st and higher order spectrums. The phase wave front information in each position can be concatenated by shifting the position of the window function. Thus, a phase wave front shape in the derived screen can be formed.

One of the methods of increasing the resolution using such a windowed Fourier transform method is to reduce the extraction radius of a window function.

However, when a small window function is used, the 0-th order spectrum and the 1st and higher order spectrums overlap each other in the wave number space by the windowed Fourier transform, and phase wave front information is affected by each other. Therefore, the recovered wave front shape is distorted. In general, the periodic stripe pattern such as moiré pattern is, in a one dimensional case for example, developed as following equation:

$$I ( x ) = {a}_{0} + {\sum }_{n = 1}^{∞} {a}_{n} cos ( \frac{2 π nx}{T} ) + {\sum }_{n = 1}^{∞} {b}_{n} sin ( \frac{2 π nx}{T} ) , \qquad ( Equation 1 )$$

wherein a first term (n=0) denotes the 0-th order spectrum, a second term (n=1) denotes the 1st order spectrum, and second, third and following terms (n=2, and 3 . . . ) denote further higher order spectrums. And, “n” denotes an order number. “X” denotes a coordinate in the one dimensional. “T” denotes moiré period. In concrete, the term “a₀” denotes the 0-th order spectrum. The “aₙ” and “bₑ” denote factors forming the further higher (n-th) order spectrum. As shown in the Equation, the above described higher order spectrum may have an arbitrary infinite order number. For the purpose of simplifying explanation, it is assumed such that only the 0-th order spectrum and the 1-th order spectrum are described as substantially contributing the moiré wave form, and the further higher order spectrums are negligibly smaller, in the following description.

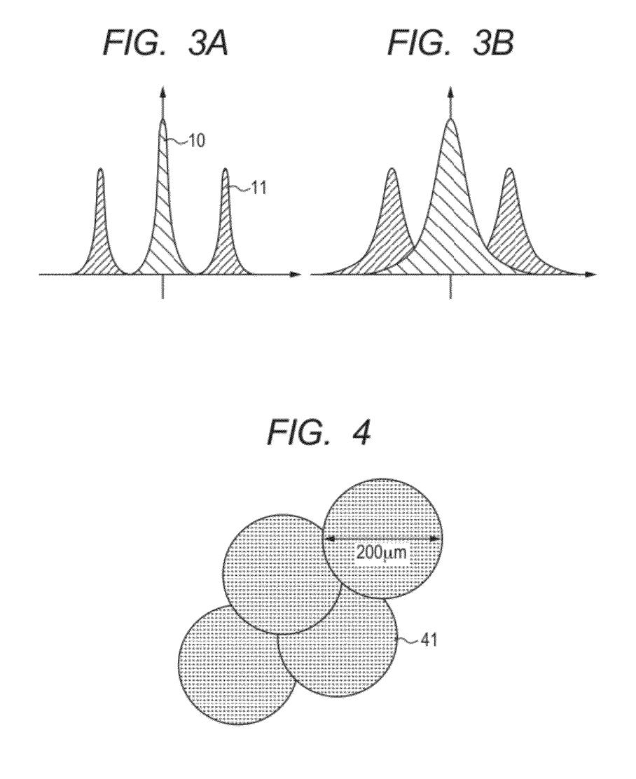

FIGS. 3A and 3B each illustrate a schematic drawing of a moiré pattern subjected to windowed Fourier transform by a window function.

In FIGS. 3A and 3B, reference numeral 30 denotes a 0-th order spectrum and reference numeral 31 denotes a 1st order spectrum.

FIG. 3A illustrates a case in which a large window function is used. FIG. 3B illustrates a case in which a small window function is used.

In FIG. 3A, each of the 0-th order spectrum located in the center and the 1st order spectrums located on both sides is substantially an independent spectrum and thus information about the 1st order spectrum may be used as the value of the spectrum. Further, if spectrum information is derived in this manner, the recovered phase wave front image is unlikely to be distorted. In contrast to this, in FIG. 3B, each of the 0-th order spectrum and the 1st order spectrums extends laterally at its lower portion so as to interfere with each other. As a result, the 0-th order spectral data and the 1st order spectral data overlap each other and thus it is difficult to derive information about the 1st order spectrum independently. Therefore, an accurate phase wave front shape cannot be derived, but superimposed data of the 0-th order spectrum and the 1st order spectrum is derived simply by extracting a value of the 1st order spectrum.

On the contrary, the configuration of the present embodiment can further improve the resolution eliminating the effect of the 0-th order spectrum by analytically separating the 0-th order spectrum and the 1st order spectrum from a windowed Fourier component regardless of the size of a window function to be used.

Further, as a configuration of the present embodiment, such a phase information analyzing method may be configured as a phase information analyzing program to be executed by a computer.

Furthermore, the present embodiment may be configured as a computer readable storage medium storing the phase information analyzing program.

Next, the phase information analyzing method according to the present embodiment will be described with a main emphasis on calculation of phase wave front information.

Non Patent Literature 1 introduces a method called Carrier Fringe using a windowed Fourier transform method for calculating an interference pattern.

The present embodiment improves the calculation of phase wave front information in the conventional windowed Fourier transform method by which part of a periodic pattern of moiré is extracted by a window function and is subjected to a Fourier transform; and then the phase is sequentially determined from data of the spectrum.

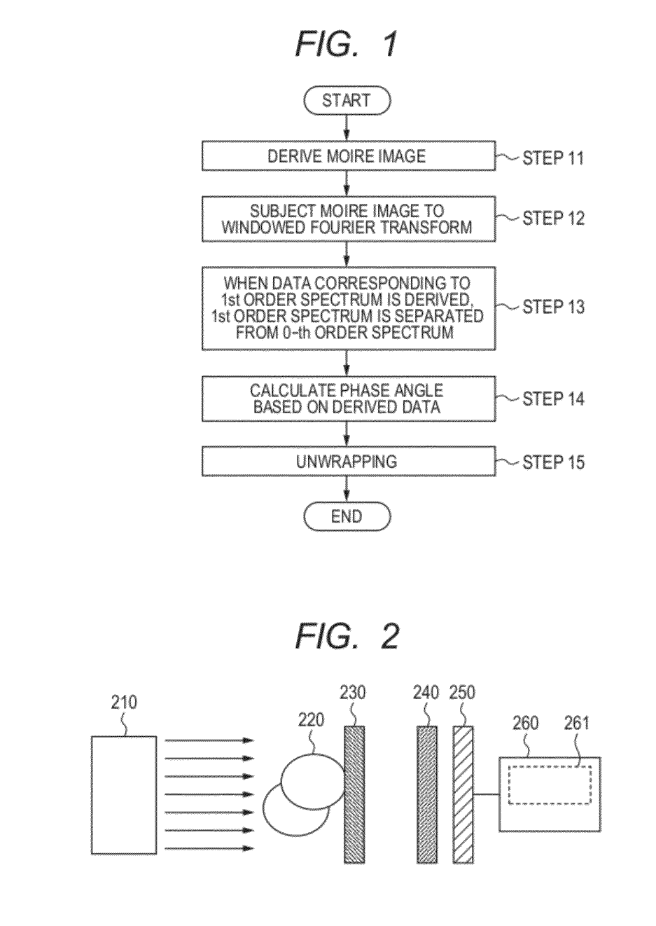

FIG. 1 is a flowchart according to the present embodiment illustrating an improved procedure for calculation by a conventional windowed Fourier transform method.

As illustrated in FIG. 1, first, in step 11, a moiré image (an interference pattern) is derived. Then, in step 12, the derived moiré image is subjected to a windowed Fourier transform.

Various window functions can be used for the windowed Fourier transform.

Then, in step 13, data of particularly 1st order spectrum, namely, a spectrum matching the frequency of a moiré is extracted from the windowed Fourier transform.

At this time, the value of data in a portion corresponding to the derived 1st order spectrum is used as is in the conventional method, while in the present embodiment, the 0-th order spectrum and the 1st order spectrum are analytically separated to eliminate the effect of the 0-th order spectrum from the 1st order spectrum.

For this purpose, the difference is calculated on the assumption that data of the 0-th order spectrum is superimposed on data of the 1st order spectrum.

In order to calculate the difference, a procedure is added for deriving data of a spectrum corresponding to the 0-th order spectrum and analytically calculating information about the 0-th order spectrum superimposed on the 1st order spectrum.

Here, assuming that for high speed processing, both shapes of the 0-th order spectrum and the 1st order spectrum can be approximated by Gaussian, a procedure for separating two spectrums by fitting is used.

Then, in step 14, an amount of change in phase wave front is calculated by calculating a phase angle from the derived data.

The phase angle calculated in the above step is data wrapped from −π to π. Thus, in step 15, phase unwrapp is performed for analyzing a breakpoint thereof for correction.

Thus, an image obtained free from the effect of the 0-th order spectrum by analytically separating the 0-th order spectrum and the 1st order spectrum from a windowed Fourier component is used as information indicating the change in wave front or the differentiation thereof.

The change in phase wave front can be obtained by further integrating the differentiation information. In the above description, for the purpose of simplifying the explanation, the embodiment including only the 0-th order spectrum and the 1-th order spectrum is described. Practically, according to the moiré wave form, further higher order (n=2, 3, . . . ) of spectrums in the Equation 1 may be originated. And, the further higher order (n=2, 3, . . . ) of spectrums can be calculated and separated from the 0-th order spectrum within a scope and spirit of the present invention, to derive desirable characteristic.

Hereinafter, using FIG. 2, a configuration example of an X-ray phase imaging apparatus of the present embodiment will be described. The present embodiment focuses particularly on a configuration example of an X-ray phase imaging apparatus as an interference system using a Talbot interferometer.

The X-ray phase imaging apparatus has drawn much attention in recent years for medical applications. In the medical applications, a human body is the object and thus the technique for deriving an image of fine structure thereof with good accuracy is indispensable.

Of them, currently the Talbot interferometer has been actively studied as a candidate for medical X-ray phase imaging.

It should be noted that the present invention is not limited to the Talbot interferometer or the X-ray phase imaging apparatus, but may be applied to general measurement techniques using a moiré or periodic pattern.

The detail about the X-ray phase imaging apparatus using the Talbot interferometer is found in “A. Momose, et al., Jpn. J. Appl. Phys. 42, L866 (2003)”.

FIG. 2 illustrates a configuration example of the X-ray phase imaging apparatus (X-ray imaging apparatus) using the Talbot interferometer.

In FIG. 2, reference numeral 210 denotes an X-ray source, reference numeral 220 denotes an object, reference numeral 230 denotes a phase grating (diffraction grating), reference numeral 240 denotes an absorption grating, reference numeral 250 denotes a detector, reference numeral 260 denotes an calculator, and reference numeral 261 denotes a CPU.

The following description focuses on the process flow using the X-ray phase imaging apparatus, from X-ray generation, its transmission through the object up to acquisition of phase information (phase wave front).

The phase grating 230 constitutes a unit for modulating the phase or the intensity of the X-ray which is emitted from the X-ray source and transmitted through the object.

The absorption grating 240 blocks part of an interference pattern (Talbot image) formed by Talbot effect caused by the phase grating 230 and forms a moiré on a detection surface of the detector 250. The absorption grating 240 and the phase grating 230 are spaced apart by a so-called Talbot distance.

The detector 250 detects the moiré and takes an image thereof.

The calculator 260 constitutes a unit for deriving phase information of an X-ray incident on the phase grating based on the moiré derived by the detector 250, and has a computer system causing a computer to execute the above described phase information analyzing method of the present invention.

Here, the operation of the above configuration will be described. First, the X-rays generated by the X-ray source 210 which is a radiation generation section transmit through the object 220.

When the X-rays transmit through the object 220, the X-rays undergo a change and an absorption of the wave front depending on the shape and the like of the object 220.

The X-rays transmitted through the object 220 and then transmit through the phase grating 230 to form an interference pattern. The X-rays transmit through the absorption grating 240 provided in a position in which the interference pattern is formed and form a moiré so as to match the resolution of the imaging apparatus.

The intensity information of the moiré of the X-rays transmitted through the absorption grating 240 is detected by the detector 250. The detector 250 refers to an element capable of detecting intensity information of the interference pattern of radiation. Examples of the detector 250 include an imaging apparatus such as a CCD (Charge Coupled Device).

The intensity information of the interference pattern detected by the detector 250 is analyzed by the calculator 260 performing an arithmetic operation in each step of the above described analyzing method and is converted to phase differential information, namely, an image obtained by differentiating the wave front in a specific axial direction.

Note that the calculator 260 includes a CPU (Central Processing Unit) 261. The object 220 may be interposed between the phase grating 230 and the absorption grating 240.

### Embodiments

Hereinafter, the present embodiment will be described.

### First Embodiment

In the present embodiment, an example of calculation by computer simulation will be described. The parameters used in the simulation are as follows.

First, an assumption is made that the X-rays emitted from the X-ray source 210 are coherent incident X-rays each with an energy of 17.7 keV and a wavelength of 0.7 Å, namely, with a constant phase wave front.

The incident X-rays undergo a change in phase wave front by the object 220. The object used in the present embodiment is assumed to be made of four calcium phosphate spheres 41 each with a diameter of 200 μm overlapped as illustrated in FIG. 4.

Here, a 4 μm stripe π grating (stripe pattern) is used as the above described phase grating.

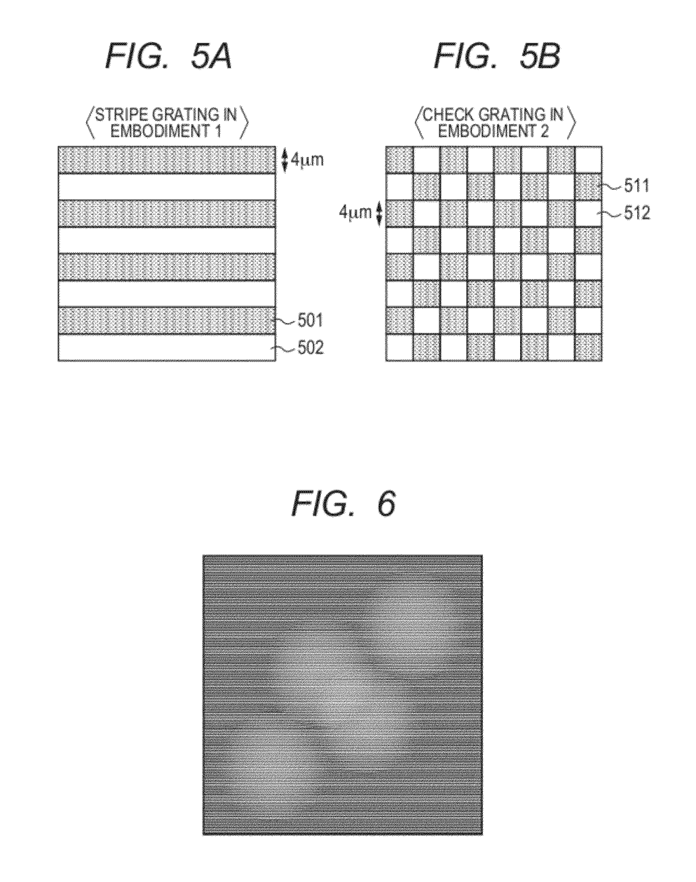

Here, the 4 μm stripe π grating refers to a stripe pattern in which as illustrated in FIG. 5A, a portion 501 with the phase of the incident X-ray subjected to π change and a portion 502 with the phase subjected to no change are provided at 1:1 ratio, and a pair of stripe patterns has a period of 4 μm in width.

An example of a moiré image detected by the detector 250 is as illustrated in FIG. 6.

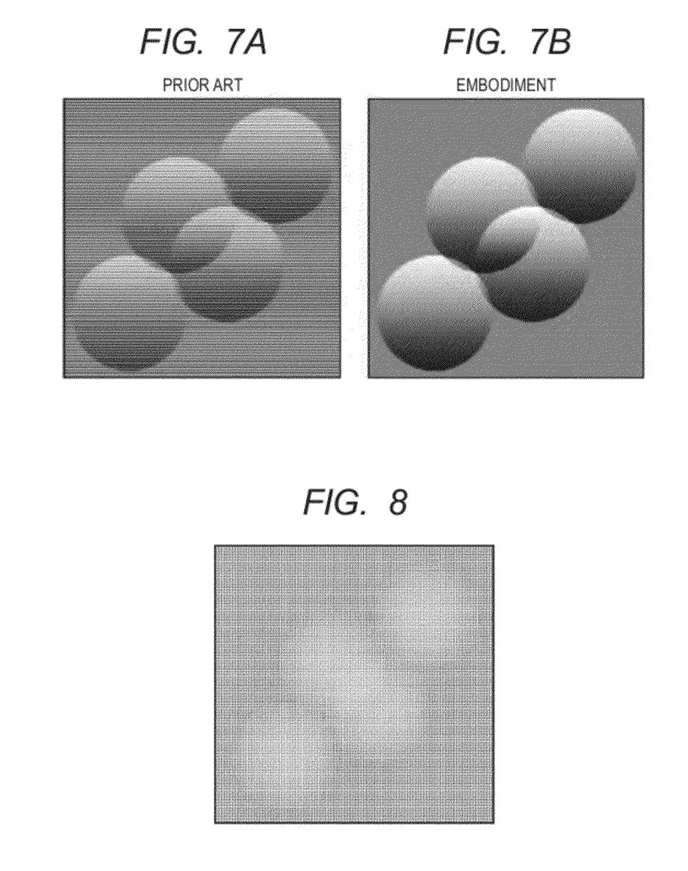

The moiré image subjected to wave front recovery is as illustrated in FIG. 7B.

For comparative purpose, FIG. 7A illustrates a result in prior art and FIG. 7B illustrates a result in the present embodiment.

Note that as the prior art, the result based on the Non Patent Literature 1 is illustrated.

Note also that Gaussian is used as the window function. The size of the full width at half maximum of the window function is assumed to be two pixels on the image.

The present embodiment is different from the prior art in step 13 in the procedure for calculating wave front information illustrated in FIG. 1.

In the prior art, as the reference data, when data in the portion corresponding to the 1st order spectrum is derived, the value of the data is used simply as is, while in the present embodiment, a procedure for analytically separating the 0-th order spectrum and the 1st order spectrum is added thereto. This process has been described in the above embodiment and thus the duplicate description is omitted.

FIGS. 7A and 7B illustrate how different in the differential image of the recovered phase wave front between the prior art and the present embodiment.

In the prior art, the image has a pattern of horizontal-stripes. This is a false image which occurs because the 0-th order spectrum image is superimposed on the 1st order spectrum image when the windowed Fourier transform is performed. In contrast to this, such a pattern of horizontal-stripes is not found in the present embodiment because the 0-th order spectrum is separated.

This proves that the present invention is effective. In order to reproduce the fine structure of the object, the smaller the window function is, the more effective the present invention is.

### Second Embodiment

Unlike the first embodiment using a stripe pattern as the phase grating, the second embodiment uses a 4 μm checkerboad π grating (checkerboad pattern).

Here, the 4 μm checkerboad π grating refers to a shape in which a portion 511 with the phase subjected to π change and a portion 512 with the phase subjected to no change alternately appear into a checkerboad pattern as illustrated in FIG. 5B.

The size of the full width at half maximum of the window function is two pixels on an image in the same manner as in the first embodiment. The moiré image detected at this time by the detector 250 has a 2D structure as illustrated in FIG. 8.

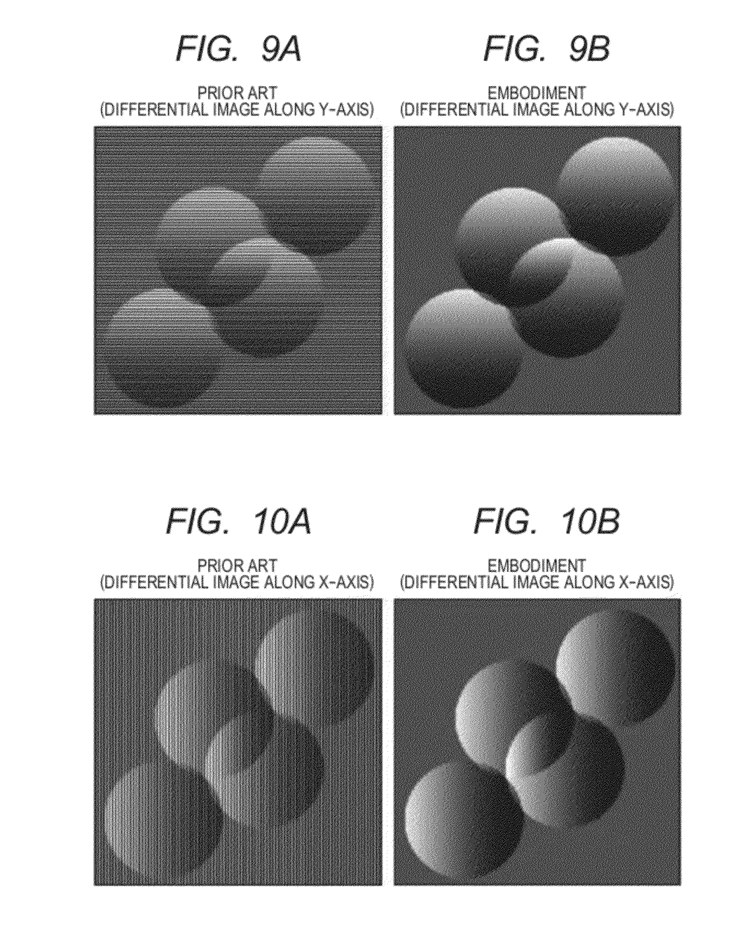

FIGS. 9A to 10B each illustrate a differential image of the recovered phase wave front for comparison between the prior art and the present embodiment. FIG. 9A illustrates a phase wave front differential image along the Y-axis in prior art. FIG. 9B illustrates a phase wave front differential image along the Y-axis in the second embodiment. FIG. 10A illustrates a phase wave front differential image along the X-axis in the second embodiment. FIG. 10B illustrates a phase wave front differential image along the X-axis in prior art.

Like the first embodiment, the present embodiment adds a procedure for analytically separating the 0-th order spectrum and the 1st order spectrum to step 13 of calculating a wave front.

In the prior art without performing such separation, striped patterns are superimposed.

In contrast to this, in the present embodiment, a clear image without unwanted striped patterns being superimposed can be derived in the phase differential image along both the X and Y axes.

This proves that the present invention is effective regardless of whether the structure of the moiré is one dimensional or two dimensional. The shape of a moiré can be used to analyze the change in wave front or information about the phase from the change in shape of the moiré.

Hereinbefore, the preferred embodiments of the present invention have been described, but the present invention is not limited to these embodiments, and various modifications and changes can be made without departing from the spirit and scope of the present invention.

For example, the present invention is not limited to an apparatus such as an X-ray apparatus and a Talbot apparatus used in the first embodiment and the second embodiment described above, but can be used for a general moiré image analysis using an electromagnetic wave with a wavelength range longer than that of an X-ray such as visible light. Thus, the present invention can be used for a moiré image analysis by interference of a wave with a wavelength including light or an X-ray.

Further, in the above described embodiments, the analysis is performed by subjecting the window function for the windowed Fourier transform to Gaussian, but this is simply an example and does not mean to limit the shape of the window function of the present invention to these. Any shape of window function and the analysis method corresponding to this may be used.

Note that the technical elements described in the description or the drawings exert technical usefulness alone or in various combinations, and are not limited to the combinations described in the claims at the time of filing. Also, the techniques illustrated in the description or the drawings simultaneously achieve a plurality of objects, and have technical usefulness simply by achieving one of the objects.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-027214, filed Feb. 10, 2010, which is hereby incorporated by reference herein in its entirety.

1. An analyzing method for deriving phase information by analyzing a periodic pattern of moiré comprising steps of:
subjecting at least a part of the periodic pattern of moiré to a windowed Fourier transform by a window function; and
separating analytically, based on the moiré subjected to the windowed Fourier transform, information of a first spectrum carrying the phase information, from information of a second spectrum superimposed on the information of the first spectrum, to derive calculating the phase information.

2.-6. (canceled)

7. The analyzing method according to claim 1, wherein the separating analytically to separate, based on calculation using equation of two or more data of the moiré subjected to the windowed Fourier transform, information of the first spectrum carrying the phase information, from information of the second spectrum carrying no phase information superimposed on the information of the first spectrum carrying the phase information.

8. The analyzing method according to claim 1, wherein the windowed Fourier transform is formulated such that the first spectrum carrying the phase information and the second spectrum carrying no phase information are superimposed on each other.

9. The analyzing method according to claim 1, wherein, in the step of separating, Fourier component derived from the first spectrum is separated from a Fourier component on a coordinate in the wave number space in which the first spectrum and the second spectrum are superimposed on each other.

10. The analyzing method according to claim 1, wherein, under an assumption that the first spectrum carrying the phase information and the second spectrum carrying no phase information have respectively in a form of the windowed Fourier function, those information of the spectrum are separated analytically.

11. The analyzing method according to claim 1, wherein as the window function, a Gaussian is used.

12. A non-transitory computer-readable storage medium storing, in executable form, a program for operating a computer to execute the analyzing method according to claim 1.

13. (canceled)

14. An X-ray imaging apparatus comprising:
a diffraction grating for diffracting X-rays from a X-ray source;
an absorption grating for shielding a part of the X-rays diffracted by the diffraction grating;
a detector for detecting the moiré of the X-rays passing through the absorption grating; and
a calculator for deriving a phase information of the X-rays transmitted through an object, based on the moiré detected by the detector,
wherein the calculator derives the phase information according to the analyzing method according to claim 1.

15. The X-ray imaging apparatus according to claim 14, wherein the diffraction grating is formed in a stripe pattern, or checker board pattern.
